(19) United States
(12) Patent Application Publication
(10) Pub. No.: US 2015/0143729 A1
(43) Pub. Date: May 28, 2015

(54) Overhead banner stand fixture

(71) Applicant: Graphic Resource Group, Troy, MI (US)

(72) Inventors: Chester Allen Pyc, Rochester Hills, MI (US); Jason Knight, Ferndale, MI (US)

(73) Assignee: Graphic Resource Group, Troy, MI (US)

(21) Appl. No.: 14/091,732

(22) Filed: Nov. 27, 2013

(51) Int. Cl. G09F 7/18; A47F 5/10; F16M 11/22

(52) U.S. Cl. CPC G09F 7/18; F16M 11/22; A47F 5/10
USPC 40/607.1; 29/428; 29/525.01

(57) ABSTRACT

A graphic sign fixture is described for use with a vehicle. The graphic sign fixture comprises at least two legs, a sign frame system, and a graphic sign. Each leg includes an upper post section, a lower post section, and a base section. The sign frame system comprises either a silicone edge graphic frame or a first sign frame cross-section member; a second sign frame cross-section member; and a locking system. The weight of the vehicle holds the legs in an upright position when the vehicle's wheels contact the base sections. The method comprises providing a graphic sign fixture, assembling the graphic sign fixture, and placing the wheels of a vehicle in contact with the base sections of the graphic sign fixture, such that the weight of the vehicle holds the legs of the graphic sign fixture in an upright position.

### FIELD

This disclosure relates generally to a fixture or stand for use with graphic signs or banners. More specifically, this disclosure relates to a fixture or stand that is adapted to be supported by the weight of a vehicle.

### BACKGROUND

The statements in this section merely provide background information related to the present disclosure and may not constitute prior art.

Graphic signs and other indicia-bearing banners are commonly used for advertising purposes by dealers and manufacturers of various types of vehicles, such as automobiles, trucks, trailers, and the like. The conventional methods of displaying such advertising materials include the use of self-supporting tables or stands, hanging the materials from the ceiling, adherence of the materials to the vehicle's windows, or placing the materials on the vehicle. These conventional methods are deficient in that they may obstruct the view of all or part of the vehicle, interfere with one's movement around the vehicle or be cumbersome and inconvenient to install.

### SUMMARY

In one form of the present disclosure, a graphic sign fixture for use with a vehicle is provided. The graphic sign fixture generally comprises at least two legs, a sign frame system, and a graphic sign. Each leg includes an upper post section, a lower post section, and a base section. The upper post section is reversibly coupled to the lower post section and the lower post section is reversibly coupled to the base section. The sign frame system generally comprises either a silicone edge graphic frame or a combination of a first sign frame cross-section member; a second sign frame cross-section member; and a locking system used to reversibly fasten the first sign frame cross-section member to the second sign frame cross-section member. The first sign frame cross-section member is coupled to one leg, while the second sign frame cross-section member being coupled to a different leg, The locking system is used to reversibly fasten the first sign frame cross-section member to the second sign frame cross-section member. One skilled in the art will understand that the cross-section members may also be a component that makes up part of a silicone edge graphic frame when desirable. The graphic sign is attached to the silicone edge graphic frame and/or one or more of the sign frame cross-section members.

The weight of the vehicle holds the legs in an upright position, when the vehicle's wheels are in contact with the base sections. In one form, the legs and the sign frame cross-section members comprise either a solid frame or a hollow frame. The graphic sign is made out of one or more materials, such as by way of example, plastic, fabric, paper, ceramic, or the like. The graphic sign may also be a silicone edge graphic (SEG).

According to another aspect of the present disclosure, the silicone edge graphic frame or the sign frame cross-section members are coupled to the upper post section of the leg. When desirable, the graphic sign fixture may further comprise at least a third and a fourth sign frame cross-section member or a second silicone edge graphic frame. The graphic sign may be attached using rope, cord, string, Velcro, hooks, clips, or a thin silicone strip, welt or gasket, among other attachment approaches.

The locking system may be a snap button connection, a nut and bolt, or a pin, among others. Alternatively, the locking system is a snap button connection. Optionally, the fixture further may further comprise one or more snap frame signs; the snap frame signs being held in place using a mounting plate fastened to the leg.

The upper post or lower post sections are reversibly coupled by an end of one of the post sections being slideably received by an end of the other post section. Similarly, the base section or the lower post section is reversibly coupled by an end of one of the sections being slideably received by an end of the other section. The post sections and the base section are further coupled together using one selected from the group of one or more bolts and nuts, screws, pins, or the like.

According to another aspect of the present disclosure, the base section includes a base post and a flat base plate that intersect at a predetermined angle. The predetermined angle is about 90 degrees. The upright position is determined by the angle of the intersection between the base post and the base plate. The base plate is stiffened by the use of one or more angled plates that are coupled to the base plate.

The length of the legs is at least 5 feet; alternatively, greater than 7 feet; alternatively, about 10 feet. The cross-section members secure the legs in a position that is greater than 5 feet; alternatively, more than 6 feet; alternatively about 8 feet apart. The legs and the sign frame cross-section members are made out of aluminum, steel, a metal alloy, a thermoplastic, a reinforced ceramic composite, or a combination thereof.

According to another aspect of the present disclosure, the sign frame cross-section members further comprise one or more support members. The support members are fastened to the sign frame cross-section members by welding, nuts & bolts, screws, pins, adhesive, or another fastening means.

According to another aspect of the present disclosure, a method of affixing a sign for use with a vehicle is provided. The method generally comprises providing a graphic sign fixture, assembling the graphic sign fixture, and placing the wheels of a vehicle in contact with the base sections, such that the weight of the vehicle holds the legs in an upright position. The graphic sign fixture generally comprises at least two legs; a sign frame system, and a graphic sign. The sign frame system comprises either a silicone edge graphic frame or a first sign frame cross-section member, a second sign frame cross-section member, a locking system. Each leg includes an upper post section, a lower post section, and a base section. The upper post section is reversibly coupled to the lower post section and the lower post section is reversibly coupled to the base section. The first sign frame cross-section member is coupled to one leg, while the second sign frame cross-section member is coupled to a different leg. When a silicone edge graphic frame is utilized instead of the cross-section members, the frame is attached to each leg. The locking system is used to reversibly fasten the first sign frame cross-section member to the second sign frame cross-section member. The graphic sign is capable of being attached to one or more of the sign frame cross-section members or the silicone edge graphic frame.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a graphic sign fixture constructed according to teachings of the present disclosure;

FIG. 2A is a partial exploded perspective view of the graphic sign fixture constructed according to the teachings of the present disclosure;

FIG. 2B is a perspective view of the sign frame fixture in the graphic sign fixture of FIG. 1 according to one aspect of the present disclosure;

FIGS. 3A-3D are partial exploded perspective views of the sign frame system that is part of the graphic sign fixture of FIG. 1;

FIGS. 4A and 4B are partial exploded perspective views of the legs that is part of the graphic sign fixture of FIG. 1;

FIG. 5 is a partial exploded perspective view of the base section that is part of the leg of FIG. 1; and

FIG. 6 is a schematic of a method of using the graphic sign fixture of the present disclosure.

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally relates to a graphic sign fixture for use with a vehicle. The graphic sign fixture made and used according to the teachings contained herein is described throughout the present disclosure in conjunction with an automobile in order to more fully illustrate the concept. The incorporation and use of the graphic sign fixture in conjunction with other types of vehicles, including but not limited to trucks, trailers, and motor homes is contemplated to be within the scope of the disclosure.

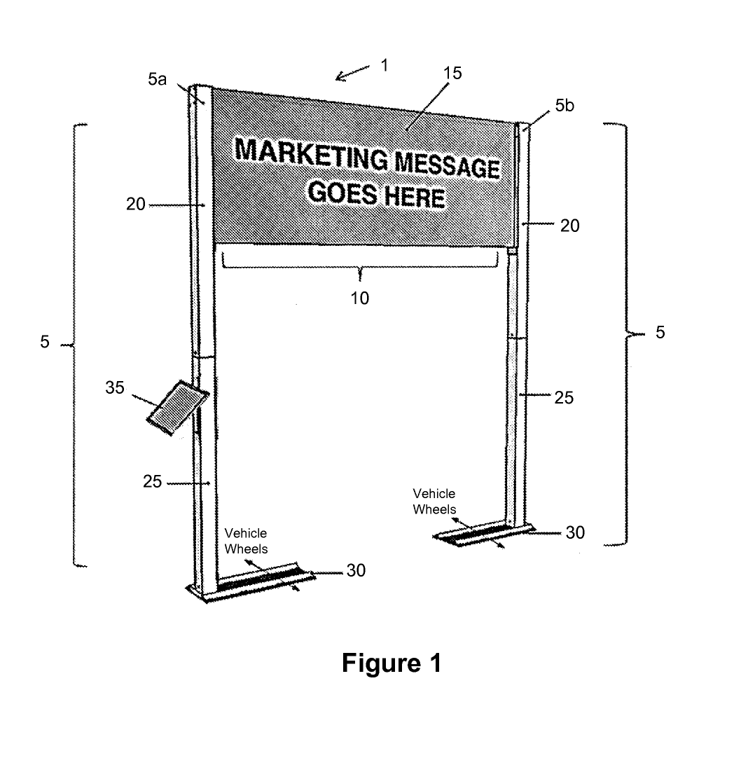

Referring to FIG. 1, a graphic sign fixture 1, constructed in accordance with the inventive concepts of the present disclosure, is illustrated in a typical application with the fixture 1 being stabilized by the weight of a vehicle having tires that rest upon a portion of the fixture 1. The graphic sign fixture 1 generally comprises at least two legs 5, a sign frame system 10, and a graphic sign or banner 15. Each leg 5 includes an upper post section 20, a lower post section 25, and a base section 30. The upper post section 20 is reversibly coupled to the lower post section 25 and the lower post section 25 is reversibly coupled to the base section 30. Optionally, the fixture 1 may further comprises one or more snap frame signs 35; the snap frame sign 35 being held in place using a mounting plate or other means fastened to the leg 5.

The length of the legs 5 of the graphic sign fixture 1 is at least 5 feet; alternatively, greater than 7 feet; alternatively, about 10 feet. The sign frame system 10 secures the legs 5 in a position that is greater than 5 feet; alternatively, more than 6 feet; alternatively about 8 feet apart. The legs may either be comprised of a solid frame or a hollow frame. The weight of the vehicle holds the legs 5 in an upright position, when the vehicle's wheels are in contact with the base sections 30 of the legs 5.

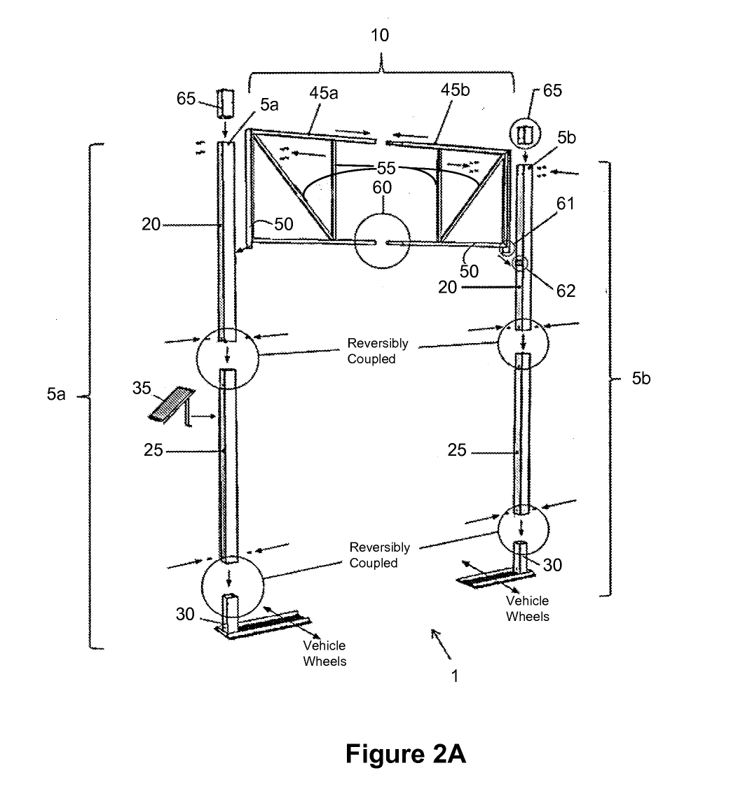

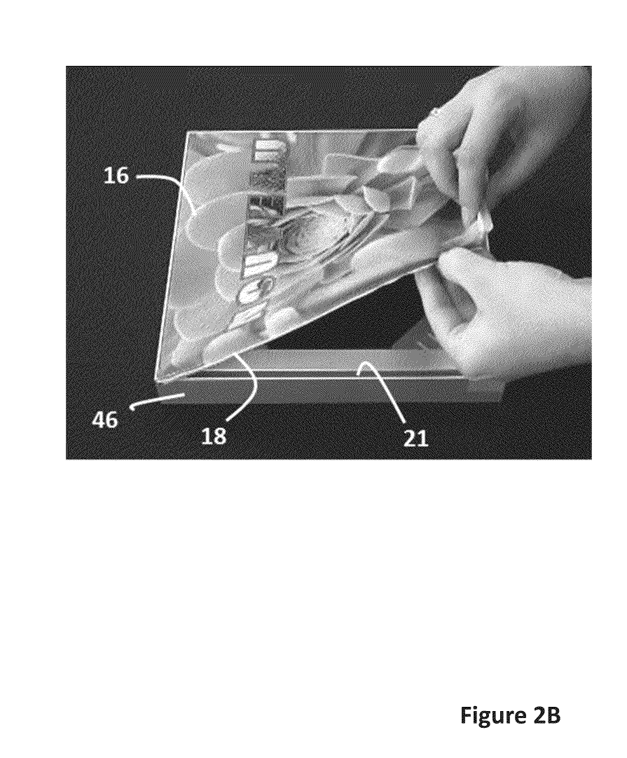

The sign frame system 10 may comprise either a silicone edge graphic frame 46 or a combination of a first cross-section member 45a; a second cross-section member 45b; and a locking system 60 used to reversibly fasten the first cross-section member 45a to the second cross-section member 45b as shown in FIGS. 2A and 2B. The first sign frame cross-section member 45a being coupled to one leg 5a, while the second sign frame cross-section member 45b is coupled to a different leg 5b. One skilled in the art will understand that the cross-section members 45 may also be a component that makes up part of a silicone edge graphic frame 46 when desirable. The silicone edge graphic frame 46 or cross-section members 45 may be coupled to a leg 5 by any means known to one skilled including but not limited to the use of a locking tab 61 located on the cross-section member 45 intersecting with a locking holder or buckle 62 located on the leg 5.

The sign frame system 10 may also comprise a locking system 60 used to reversibly fasten the first sign frame cross-section member 45a to the second sign frame cross-section member 45b. The graphic sign (best shown in FIG. 1) is capable of being attached to one or more of the sign frame cross-section members 45a, 45b. The sign frame cross-section members 45a, 45b are coupled to the upper post section 20 of the leg 5. The end of the upper post section 20 of one or more legs 5 may optionally comprise a cap insert 65.

According to one aspect of the present disclosure, the graphic sign fixture may further comprise at least a third leg 5 and either a second silicone edge graphic frame 46 or a third and a fourth sign frame cross-section member 45. In this specific instance the graphic sign fixture includes at least two separate or continuous graphic signs 15 or banners. For example, two of the legs may be supported by the front or back wheels of the vehicle, while the third leg is supported by a rear wheel of a vehicle. One graphic sign may be located across the vehicle as shown in FIG. 1, while the second banner may be located along the side of the vehicle. One skilled in the art will understand that a fourth leg may be included as part of the graphic sign fixture, as well as additional cross-section members or frames in order to support more than two graphic signs without departing from the scope of the present disclosure.

The graphic sign fixture 1 may optionally include one or more snap sign fixtures 35. Each snap sign fixture 35 being attached to one of the legs 5 by any means known to one skilled in the art, including but not limited to a mounting plate fastened to the leg 5. The snap sign fixture may also be a small silicone edge graphic frame when desirable for use with a silicone edge graphic (SEG) as further described herein.

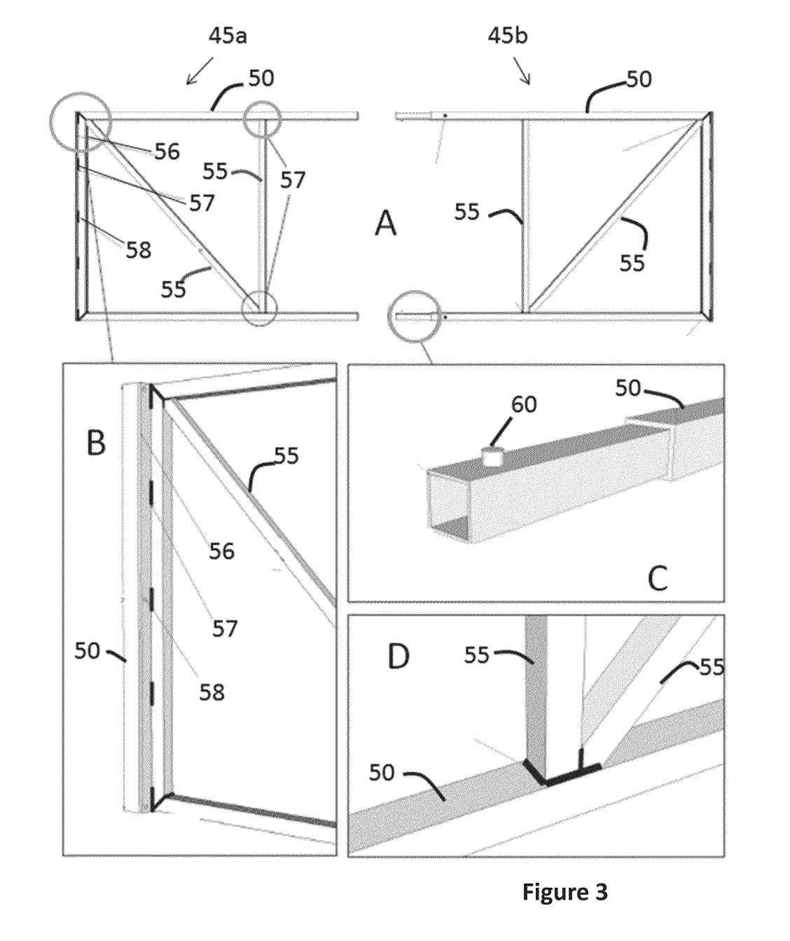

Referring now to FIGS. 3A-3D, the cross-section members 45 may be comprised of either a solid or hollow external frame or truss 50. Additional support for the truss or frame 50 is provided by lateral or angled supports or cross braces 55, and/or a plate 56 attached to the frame 50. The plate 56 and frame 50 may be made of any material known to one skilled in the art that provides the necessary or desired level of strength, including but not limited to aluminum, steel, a metal alloy, a thermoplastic, a reinforced ceramic composite, or a combination thereof. The means of attachment of the plate 56 and cross braces 55 to the frame 50 may be through the use of welding, nuts & bolts, screws, pins, adhesive, or another fastening mean. Alternatively, the plate 56, supports 55, and frame 50 is aluminum or an aluminum alloy with the means of attachment being through welds 57, bolts 58, or a mixture thereof.

The frame 50 of the first and second cross-section members 45a, 45b are coupled together via a locking system 60. The locking system 60 may comprise any reversible means of coupling the cross-section members 45a, 45b together, such as a snap button connection, a nut and bolt, a pin, or the like. Alternatively, the locking system 60 is a snap button connection as illustrated in FIG. 3C.

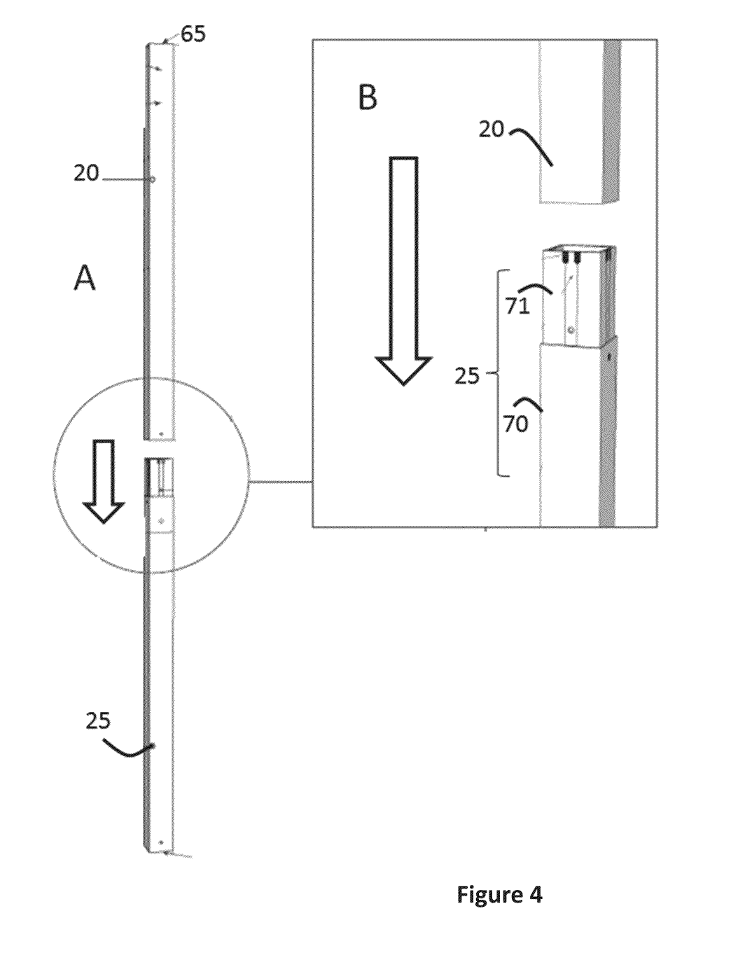

Referring now to FIG. 4A, the upper post 20 and lower post sections 25 are reversibly coupled by an end of one of the post sections being slideably received by an end of the other post section. The upper post 20 and lower post 25 sections may be further coupled together using one selected from the group of one or more bolts and nuts, screws, pins, or the like. The upper post 20 and lower post 25 sections may be made of any material known to one skilled in the art that provides the necessary or desired level of strength, including but not limited to aluminum, steel, a metal alloy, a thermoplastic, a reinforced ceramic composite, or a combination thereof. Alternatively, the upper post 20 and lower post 25 sections are made out of aluminum or an aluminum alloy. The end of the upper post section 20 may optionally comprise a cap insert 65. The cap insert 65 may be made of the same material or different material than the upper post section 20. Alternatively, the cap insert 65 is made out of aluminum or aluminum alloy, thermoplastic, rubber, or silicone material.

Referring now to FIG. 4b, the lower post section 25 may include an outer sleeve 70 and an inner sleeve 71. The inner sleeve 71 may be coupled to the outer sleeve 70 through the use of adhesives, welding, or the like. Alternatively, the inner sleeve 71 may be coupled to the outer sleeve 70 via a weld. The inner sleeve 71 of the lower post section 25 may be reversibly received by the upper post section 20. One skilled in the art will understand that the inner sleeve may be attached to the upper post section 20 and reversibly received by the lower post section 25 without exceeding the scope of the present disclosure.

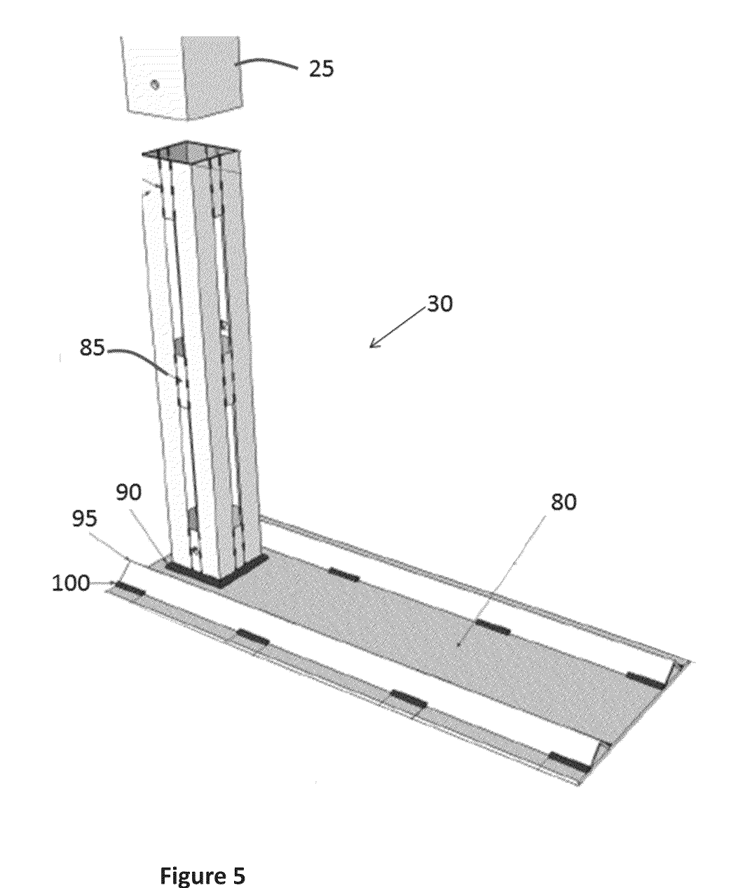

Referring now to FIG. 5, the base section 30 and the lower post section 25 are reversibly coupled by an end of one of the sections being slideably received by an end of the other section. The lower post section 25 and the base section 30 may be further coupled together using one selected from the group of one or more bolts and nuts, screws, pins, or the like. The base section 30 section may be made of any material known to one skilled in the art that provides the necessary or desired level of strength, including but not limited to metals, ceramics, or reinforced plastics. Alternatively, the base section 30 is made out of a mixture of aluminum and steel or similar alloys. The base section 30 may include a base plate 80 and a base post 85. The base post 85 and the base plate 80 are coupled together using adhesives or welding, alternatively, welding 90. The upright position of the base section 30 is determined by the angle of the intersection between the base post 85 and the base plate 80.

The upper base column 85 and the base plate 80 may be coupled together at a predetermined angle. Alternatively, the predetermined angle is about a ninety degree angle, wherein about means ±10 degrees, alternatively, ±5 degrees. The base section 30 may also be stiffened by the use of at least one angled reinforcement 95, alternatively, two angled reinforcements 95, that is coupled to the base plate 80 using either adhesives or welding, alternatively, through the use of welding. The number of welds 100 may vary, alternatively, about four welds. The angled reinforcement also serves as a chock, wedge, or block to secure the vehicle's wheel in place or to keep the wheel from moving.

The weight of the vehicle and the engagement of the base section 30 with the vehicle's wheel prevent the graphic sign fixture 1 maintains the stand in a stable condition, even when subjected to wind and other adverse conditions. The graphic sign fixture represents a high strength construction capable of resisting bending and twisting. In one form, a tire which supports the majority of the vehicle weight, such as the front wheel of a front wheel drive car, interacts with the base section 30. Since the graphic sign fixture incorporates a lightweight construction, the fixture can be easily transported and assembled by one person with relatively little effort.

The graphic sign or banner 15 may be made of vinyl, cloth, canvas, plastic, fabric, paper, ceramic, or the like. It may be of rectangular shape or any other desirable shape. The graphic sign 15 may be attached to the sign frame system 10 with a rope, cord, string, Velcro, hooks, clips, or a thin silicone strip, welt or gasket, or some other type of material of suitable length for attaching the graphic sign 15 to the sign frame system 10.

Referring again to FIG. 2b, optionally, the graphic sign or banner 15 may be a silicone edge graphic (SEG) 16. The SEG represents a high resolution, dye-sublimated fabric graphic material. This SEG 16 has a thin silicone strip 18, welt, or gasket attached, e.g., sewn, along its edge. The thin silicone strip, welt, or gasket being used to hold the SEG material to the silicone edge graphic frame upon being inserted into a recessed groove 21 present on the frame 46. In this case, the size of the SEG 16 is precise because upon the coupling of the silicone strip 18 with the recessed groove 21 in the frame 46, the SEG 16 is held taut, thereby, mimicking “hard panel” graphics conventionally found in custom displays used in interior spaces.

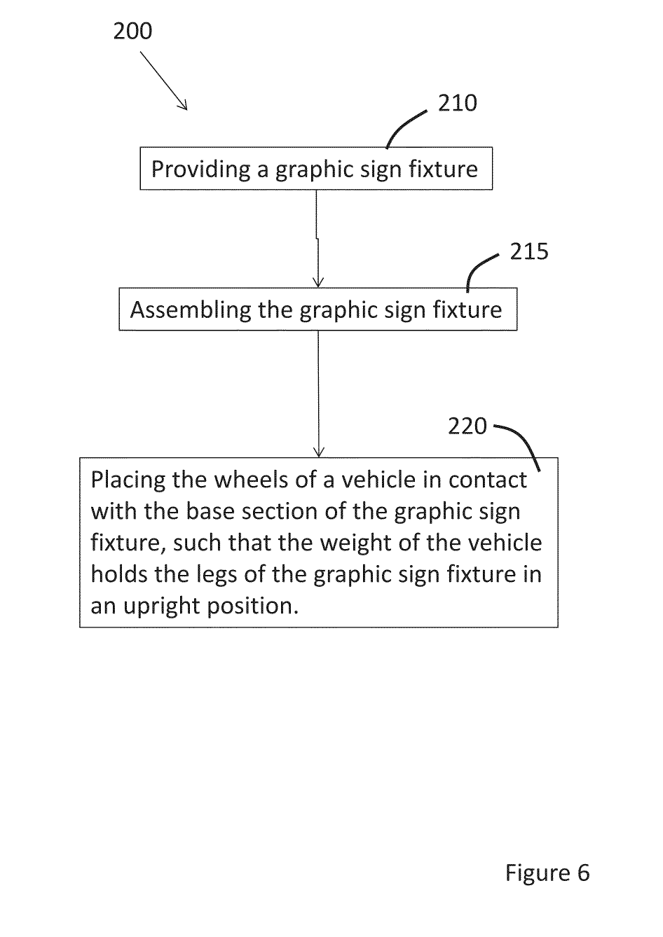

According to another aspect of the present disclosure, a method of affixing a sign for use with a vehicle is provided. Referring now to FIG. 6, the method 200 generally comprises providing 210 a graphic sign fixture constructed according to the teachings of the present disclosure, assembling 215 the graphic sign fixture, and placing 220 the wheels of a vehicle in contact with the base sections of the graphic sign fixture, such that the weight of the vehicle holds the legs of the graphic sign fixture in an upright position.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A graphic sign fixture for use with a vehicle, the graphic sign fixture comprising:
at least two legs; each leg includes an upper post section, a lower post section, and a base section; wherein the upper post section is reversibly coupled to the lower post section and the lower post section is reversibly coupled to the base section;
a sign frame system; the sign frame system comprising a first sign frame cross-section member; the first sign frame cross-section member being coupled to one leg; a second sign frame cross-section member; the second sign frame cross-section member being coupled to a different leg; and a locking system used to reversibly fasten the first sign frame cross-section member to the second sign frame cross-section member, wherein the first sign cross-section member and the second sign frame cross-section member comprise a truss structure;
a graphic sign; the graphic sign capable of being attached to one or more of the sign frame cross-section members;
wherein a weight of the vehicle holds the legs in an upright position, when wheels of the vehicle are in contact with the base sections.

2. The graphic sign fixture according to claim 1, wherein the graphic sign fixture further comprises at least a third and a fourth sign frame cross-section member.

3. The graphic sign fixture according to claim 1, wherein the sign frame cross section members are coupled to the upper post section of the leg.

4. The graphic sign fixture according to claim 1, wherein the locking system is a snap button connection.

5. The graphic sign fixture according to claim 1, wherein the upper post or lower post sections are reversibly coupled by an end of one of the post sections being slideably received by an end of the other post section.

6. The graphic sign fixture according to claim 1, wherein the base section includes a base post and a flat base plate;
wherein the base post or the lower post section are reversibly coupled by an end of one of the sections being slideably received by an end of the other section.

7. The graphic sign fixture according to claim 1, wherein the graphic sign is attached using rope, cord, string, Velcro, hooks, clips, or the like.

8. The graphic sign fixture according to claim 1, wherein the fixture further comprises one or more snap frame signs; the snap frame signs being fastened to the leg.

9. The graphic sign fixture according to claim 6, wherein the upright position is determined by the angle of the intersection between the base post and the base plate; the angle of interaction being about 90 degrees.

10. The graphic sign fixture according to claim 1, wherein the legs and the sign frame cross-section members are made out of aluminum, steel, a metal alloy, a thermoplastic, a reinforced ceramic composite, or a combination thereof.

11. The graphic sign fixture according to claim 1, wherein the sign frame cross-section members further comprise one or more support members.

12. The graphic sign fixture according to claim 6, wherein base plate is stiffened by the use of one or more angled plates that are coupled to the base plate.

13. The graphic sign fixture according to claim 1, wherein graphic sign is made out of one or more materials selected from plastic, fabric, paper, ceramic, or the like.

14. A graphic sign fixture for use with a vehicle, the graphic sign fixture comprising:
at least two legs; each leg includes an upper post section, a lower post section, and a base section; wherein the upper post section is reversibly coupled to the lower post section and the lower post section is reversibly coupled to the base section;
sign cross-section members extending between the at least two legs and comprising a truss structure;
a sign frame system; the sign frame system comprising a silicone edge graphic frame secured to the cross-section members;
a graphic sign; the graphic sign capable of being attached to the silicone edge graphic frame;
wherein a weight of the vehicle holds the legs in an upright position, when wheels of the vehicle are in contact with the base sections.

15. The graphic sign fixture according to claim 14, wherein the graphic sign fixture further comprises at least a second silicone edge graphic frame.

16. The graphic sign fixture according to claim 14, wherein the silicone edge graphic frame is coupled to the upper post sections of the at least two legs.

17. The graphic sign fixture according to claim 14, wherein the upper post or lower post sections are reversibly coupled by an end of one of the post sections being slideably received by an end of the other post section.

18. The graphic sign fixture according to claim 14, wherein the base section includes a base post and a flat base plate;
wherein the base post or the lower post section are reversibly coupled by an end of one of the sections being slideably received by an end of the other section.

19. The graphic sign fixture according to claim 14, wherein the graphic sign is attached to the silicone edge graphic frame using a silicone strip, welt, or gasket.

20. The graphic sign fixture according to claim 18, wherein the upright position is determined by the angle of the intersection between the base post and the base plate; the angle of interaction being about 90 degrees.

21. The graphic sign fixture according to claim 18, wherein base plate is stiffened by the use of one or more angled plates that are coupled to the base plate.

22. The graphic sign fixture according to claim 14, wherein graphic sign is a silicone edge graphic (SEG).

23. A method of affixing a sign for use with a vehicle, the method comprising:
providing a graphic sign fixture; the graphic sign fixture comprising:
at least two legs; each leg includes an upper post section, a lower post section, and a base section; wherein the upper post section is reversibly coupled to the lower post section and the lower post section is reversibly coupled to the base section;
a sign frame system extending between the at least two legs and defining a truss structure;
a graphic sign; the graphic sign capable of being attached to the sign frame system;
assembling the graphic sign fixture; and
placing the wheels of a vehicle in contact with the base sections, such that the weight of the vehicle holds the legs in an upright position.

24. The method according to claim 23, wherein the sign frame system comprises:
a first sign frame cross-section member; the first sign frame cross-section member being coupled to one leg;
a second sign frame cross-section member; the second sign frame cross-section member being coupled to a different leg; and
a locking system used to reversibly fasten the first sign frame cross-section member to the second sign frame cross-section member; the locking system being a snap button connection;
wherein the graphic sign is attached to one or more of the sign frame cross-section members.

25. The method according to claim 23, wherein the sign frame system comprises a silicone edge graphic frame having a recess or groove and the graphic sign is a silicone edge graphic (SEG) that includes a silicone strip, welt, gasket, or the like; wherein the silicone strip, welt or gasket is inserted into the recess or groove in order to attach the SEG to the frame.
